(19) United States
(12) Patent Application Publication
(10) Pub. No.: US 2010/0241566 A1
(43) Pub. Date: Sep. 23, 2010

(54) PAYMENT SYSTEM AND METHOD USING MESSAGE TRANSMISSION

(76) Inventor: Young-Su Kim, Uljin-gun (KR)

Correspondence Address: CANTOR COLBURN, LLP, 20 Church Street, 22nd Floor, Hartford, CT, 06103, US

(21) Appl. No.: 12/741,753

(22) PCT Filed: Nov. 10, 2008
(86) PCT No.: PCT/KR08/06615

§ 371 Date: May 6, 2010

(30) Foreign Application Priority Data
Nov. 9, 2007 (KR) 10-2007-0114583
Nov. 27, 2007 (KR) 10-2007-0121751

(51) Int. Cl. G06Q 20/00; G06F 15/16

(52) U.S. Cl. 705/44; 705/39; 709/206

(57) ABSTRACT

Provided are a payment system and method using message transmission. The payment system using message transmission includes an indicator recognizing unit and a message transmitting unit. The indicator recognizing unit recognizes a payment request indicator included in a payment request message which is transmitted from a collector terminal to a remitter terminal. The message managing unit inserts a payment means into the payment request message so as for the payment means to be output on the remitter terminal when the payment request indicator is recognized, wherein the payment means performs payment according to a payment performing input from the remitter terminal. Due to such a construction, the payment request message can be distinguished from general messages, and the payment means can be inserted into only the payment request message. Therefore, if there is a payment request input on a message screen, the payment can be immediately performed. Accordingly, it is possible to simplify payment steps and to reduce inconvenience of payment. In addition, it is possible to reduce a security danger such as personal information leakage and to facilitate payment between persons.

### TECHNICAL FIELD

The present invention relates to an on-line payment system and method, and more particularly, to an on-line payment system and method of performing payment using message transmission between communication terminals.

### BACKGROUND ART

Recently, Internet technologies have been greatly developed. Works or transactions that have been conventionally performed off-line can be performed anytime anywhere by Internet users. For example, shopping, taking educational lectures or contents, outputting civil affaire documents, paying public imposts, or the like are performed on the Internet. In addition, payment of fees for such services is also performed on the Internet.

However, in conventional payment methods using the Internet, since users need to separately subscribe the associated sites of providing the service, the payment processes are inconvenient. If a site of proving service is not well-known, there is a security danger such as personal information leakage.

In a case where payment between persons is performed, since a remitter needs to access an Internet banking site and directly input information on a counter party, the payment process is inconvenient, and there may be a problem of making a mistake of inputting collection information.

### DISCLOSURE OF INVENTION

### Technical Problem

In order to solve the conventional problems, the present invent is to provide an on-line payment system capable of reducing inconvenience of payment, reducing a security danger such as personal information leakage, and facilitating payment between persons.

### Technical Solution

According to an aspect of the present invention, there is provided a payment system using message transmission, which comprises an indicator recognizing unit and a message transmitting unit. The indicator recognizing unit recognizes a payment request indicator included in a payment request message which is transmitted from a collector terminal to a remitter terminal. The message managing unit inserts a payment means into the payment request message so as for the payment means to be output on the remitter terminal when the payment request indicator is recognized, wherein the payment means performs payment according to a payment performing input from the remitter terminal.

Due to such a construction, the payment request message can be distinguished from general messages, and the payment means can be inserted into only the payment request message. Therefore, if there is a payment request input on a message screen, the payment can be immediately performed. Accordingly, it is possible to simplify payment steps and to reduce inconvenience of payment. In addition, it is possible to reduce a security danger such as personal information leakage and to facilitate payment between persons.

The payment request message transmitted from the collector terminal may include collection information which is needed so as for a collector to collect a payment amount. The collection information may include remitter identification information through which the collector terminal can identify the remitter when the payment is performed. The remitter terminal selects the payment means from the collection information. Namely, information on collector's desired payment means among information on various types of payment means is inserted into the payment request message, the remitter can select a remitter's desired payment means among the collector's desired payment means.

In addition, the payment performing input is input from the remitter terminal. The payment performing input may include remittance information corresponding to the selected payment means. The remittance information may be directly input from the remitter terminal. In addition, the remittance information may be selected among various types of remittance information that are registered in advance in the payment system.

In addition, the payment request indicator may be an indicator which is set between the indicator recognizing unit and the remitter terminal or between the indicator recognizing unit and the collector terminal. In the former case, the indicator recognizing unit recognizes the payment request indicator from a message transmitted from the indicator recognizing unit to the remitter terminal, and the payment is performed. In the latter case, the indicator recognizing unit recognizes the payment request indicator from a message transmitted from the collector terminal to the indicator recognizing unit, and the payment is performed.

Since the payment request indicator is set in advance and collector's or remitter's desired indicator or phrase can be used as the payment request indicator, users can conveniently use the payment system, and spam message can be distinguished from the payment message in the remitter terminal.

According to another aspect of the present invention, there is provided a payment system using message transmission, which comprises a message transmitting unit and a payment means transmitting unit. The message transmitting unit transmits to a remitter terminal a payment request message including collection information transmitted from a collector terminal. The payment means transmitting unit transmits to the remitter terminal a message including a payment means, wherein, in a case where, a payment means input request of the remitter terminal is recognized, the payment means performs payment when the remitter terminal inputs a payment performing input.

Due to such a construction, there is no need to distinguish the payment request message from general messages in the payment system, and only if there is a payment means input request, the message including the payment means is transmitted to perform payment. Therefore, in case of payment system error, although a payment request message which is not inserted with a payment means due to failure of indicator reorganization is transmitted to the remitter terminal, the remitter can perform payment. In addition, the collection information can be checked, only if there is an input. Accordingly, it is possible to reduce a security danger.

According to another aspect of the present invention, there are provided payment methods using message transmission corresponding to the above payment systems.

### Advantageous Effects

According to the payment system of the present invention, since the payment is performed on the only message including the payment request indicator set in advance, it is possible to reduce the inconvenience of payment, to reduce the security danger such as personal information leakage, and to facilitate payment between persons.

### BRIEF DESCRIPTION OF DRAWINGS

FIG. 1 is a schematic block diagram showing a payment system using message transmission according to an embodiment of the present invention.

FIG. 2 is a schematic block diagram showing services provided according to settings between a payment system and a collector terminal according to another embodiment of the present invention.

FIG. 3 is a schematic block diagram showing services provided according to settings between a payment system and a collector terminal and a remitter terminal according to another embodiment of the present invention.

FIG. 4 is a schematic block diagram showing a payment system using message transmission according to another embodiment of the present invention.

FIG. 5 is a flowchart showing a payment method using message transmission according to another embodiment of the present invention.

FIG. 6 is a flowchart showing a payment method in a case where a payment system is connected to a collector terminal according to another embodiment of the present invention.

FIG. 7 is a flowchart showing a payment method in a case where a payment system is connected to a collector terminal or a remitter terminal according to another embodiment of the present invention.

FIG. 8 is a flowchart showing a payment method using message transmission according to another embodiment of the present invention.

### BEST MODE FOR CARRYING OUT THE INVENTION

Hereinafter, the present invention will be described in detail by explaining exemplary embodiments of the invention with reference to the attached drawings. For the better understanding of the present invention, like reference numerals in the drawings denote like elements.

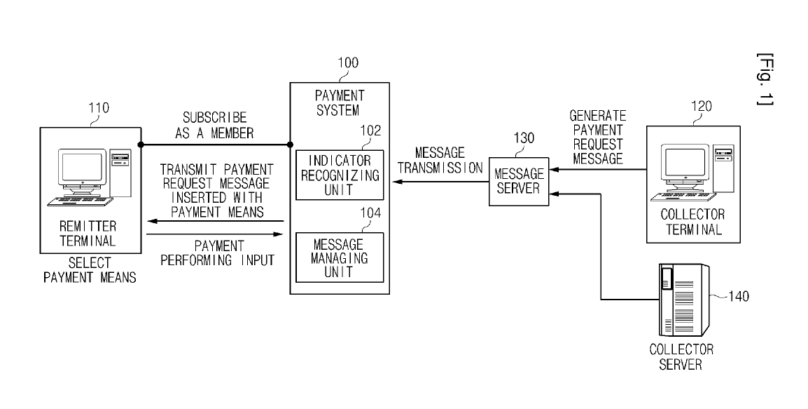

FIG. 1 is a schematic block diagram showing a payment system 100 using message transmission according to an embodiment of the present invention. In FIG. 1, services are provided according to settings between the payment system 100 and a remitter terminal 110. In order to simplify payment steps in the Internet, the payment system 100 includes an indicator recognizing unit 102 and a message managing unit 104.

The indicator recognizing unit 102 recognizes a payment request indicator included in a payment request message transmitted from the collector terminal 102 to the remitter terminal 110. The collector terminal 120 may be a PC, a notebook computer, a mobile phone, a PDA, or the like that is connected to a collector's card terminal where payment from the remitter terminal 110 can be performed or that can identify a deposit account number. The remitter terminal 110 may be a PC, a notebook computer, a mobile phone, a PDA, an Internet phone, a wire/wireless phone, a cable TV, or the like that can send and receive messages such as an e-mail, a instant messenger message, and an SMS text message, can receive an input such as a card number and a disbursement account number required for remitter's payment.

Hereinafter, the remitter terminal 110 and the collector terminal 120 are exemplified with a PC or a notebook computer. In this case, the aforementioned message is preferably an ‘e-mail message.’

In addition, the kind of the message can be changed according to the kinds of the remitter terminal 110 and the collector terminal 120. For example, in a case where the remitter terminal 110 is a mobile phone or a PDA and the collector terminal 120 is a PC or a notebook computer, the aforementioned message is preferably an SMS text message.

In addition, the indicator recognizing unit 102 can distinguish a payment request message from general messages according to whether to recognize the payment request indicator. In the message managing unit 104, a payment means can be inserted into only the payment request message recognized with the payment request indicator.

The payment request indicator is an indicator that is set between the indicator recognizing unit 102 and the remitter terminal 110, which corresponds to a case that a remitter subscribes as a member of the payment system 100 so that the payment system 100 is connected to the remitter terminal 110. The indicator can be located at any position of the message, for example, a title of the message or a body of the message. The indicator can be expressed in such a format as an e-mail address, an account number, a phrase, a word, and a special character. The indicator can be set by the remitter or the payment system. In this manner, the payment request indicator is set in advance, so that payment can be performed without any payment format that is set between the collector terminal 120 and the payment system 110.

Next, when the payment request indicator is recognized by the indicator recognizing unit 102, the message managing unit 104 inserts the payment means into the payment request message so that the payment means can be output to the remitter terminal 110 according to a payment performing input from the remitter terminal 110 (a signal representing that the remitter accepts the payment).

The payment means may be any means that can perform the payment using only the information of remitter. In general, the payment means is a computer program. At present, in the Internet, various types of on-line payment means (for example, a deposit-without-deposit system, a card payment system, a mobile-phone payment system, a point payment system, or the like) are used.

Accordingly, since payment can be performed directly on a message screen without access to a separate site for payment (for example, a financial institution site), it is possible to simplify payment steps and to reduce inconvenience of payment. Therefore, since there is no need to construction a payment server, such a small-sized company can reduce business expenses.

In addition, it is possible to reduce such a security danger as personal information leakage and to facilitate payment between persons.

The payment request message which is transmitted from the collector terminal 120 may include collection information which is needed to collect a payment amount. The collection information may include at least one of a deposit account number, a card terminal number, mobile phone collection information, and a payable point history, corresponding to the aforementioned payment means.

In addition, the collection information may include remitter identification information through which the remitter can be identified when the payment performing input is input. The identification information can be represented by a character, a number, or other various types.

In addition, the remitter identification information may be included in the payment performing input of the remitter. As a result, after the payment is completed, the collector can accurately identify a person who perform the payment and a ground for the payment.

In a case where a collector (a manager of a club) is to receive payment of registration fees of several events (for example, September, October, and November events) from a plurality of remitters (members of the club), the remitters directly input remitter identification information including the name of the remitters (for example, Hong Gildong) and the name of event for which the registration fee is paid, and the remitter identification information is transmitted to the collector terminal 120. Accordingly, it is possible for the collector to easily manage a list of payment of the registration fee for several events.

The remitter terminal 110 selects the payment means with reference to the collection information. Namely, the collector's desired types of collection information among various types of collection information are included in the payment request message, and the remitter selects a remitter's desired payment means with reference to the included collection information.

For example, if the collector's desired types of collection information included in the payment request message are deposit account information and card terminal number, the remitter may select the card payment among the above types of payment means with reference to the card terminal number and perform payment performing input.

The payment performing input may include remittance information (for example, remitter's disbursement account number, card number, mobile phone number, or point payment information). The remittance information may be directly input by the remitter, or the remittance information stored in advance in the payment system 100 may be selected.

In a case where the remittance information stored in the payment system 100 is provided, the remitter does not need to separately perform inputting, so that it is possible to simplify payment steps and to reduce inconvenience of payment. Even in a case where the stored remittance information is provided, the remitter can directly input the remittance information for payment. The input remittance information may be transmitted to the payment system 100 or directly linked to a payment agency, a card company, or a financial institution through a message, so that the payment can be safely completed.

Now, applications of the payment system 100 are exemplified. In a case where the payment request indicator is set as an e-mail address, a remitter who is to purchase products or reserve movies or train tickets leaves remitter's e-mail address and a message of requesting the collector terminal 120 to transmit the payment request message instead of directly performing the payment in the associated site.

The collector terminal 120 which acquires the remitter's e-mail address transmits the payment request message to the e-mail address. The payment system inserts the payment means to a message including the e-mail address that is set as the payment request indicator and transmits the message to the remitter terminal 110, so that the payment can be performed.

In addition, if the payment system 100 is used for the payment of public imposts and others or in the payment between persons, the collector terminal 120 transmits a message including only the payment request indicator and the collection information including a deposit amount, a deposit account number, and a deposit due date without generation of separate payment formats, so that it is possible to simplify the payment.

Conventionally, in case of the payment of public imposts, the payment using a message cannot be performed due to security problem. According to the present invention, the payment using a message can be performed, so that associated message management companies can make profit continuously.

As another example, there is e-mail advertisement. An advertiser inserts advertizing contents (including description of products, prices thereof, and the like) and the payment request indicator (set by the collector terminal 120 connected to the payment system 100 or set by the payment system 100) into an advertising mail through the collector server 140. The advertiser transmits to an arbitrary remitter terminal 110 the advertising mail by using the payment system 100. If the remitter who checks the advertising mail through the remitter terminal 110 desires to purchase some of the advertised products, the remitter performs payment performing input just on the e-mail so as to perform payment.

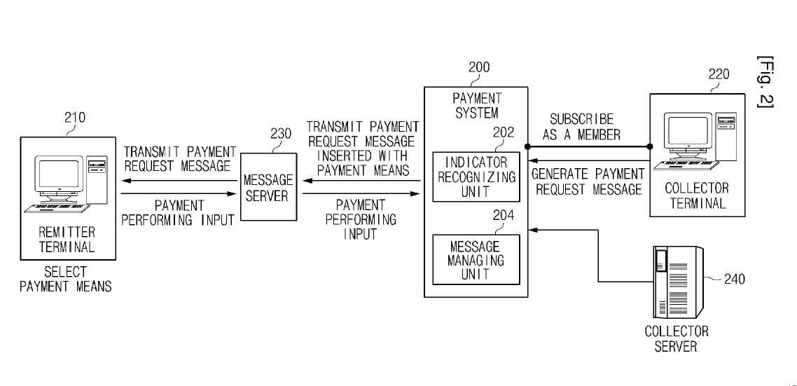

FIG. 2 is a schematic block diagram showing services provided according to settings between a payment system 200 and a collector terminal 200 according to another embodiment of the present invention. The indicator recognizing unit 202 recognizes a payment request indicator included in a payment request message transmitted from the collector terminal 202 to the remitter terminal 210. The payment request indicator is an indicator that is set between the indicator recognizing unit 202 of the payment system 200 and the collector terminal 220, which corresponds to a case that a collector subscribes as a member of the payment system 200 so that the payment system 200 is connected to the collector terminal 220.

The indicator can be located at any position of the message, for example, a title of the message or a body of the message. The indicator can be expressed in such a format as an e-mail address, an account number, a phrase, a word, and a special character. The indicator can be set by the collector or the indicator recognizing unit 202 of payment system 200.

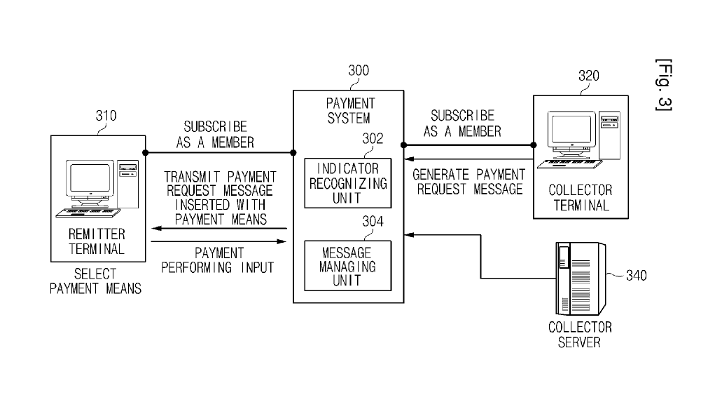

FIG. 3 is a schematic block diagram showing services provided according to settings between a payment system 300 and a remitter terminal 310 and a collector terminal 320 according to another embodiment of the present invention. A indicator recognizing unit 302 recognizes a payment request indicator which is included in a payment request message transmitted from the collector terminal 320 to the remitter terminal 310. The payment request indicator is an indicator that may be set between the indicator recognizing unit 302 and the collector terminal 320, between the indicator recognizing unit 302 and the remitter terminal 310, or by the indicator recognizing unit 302.

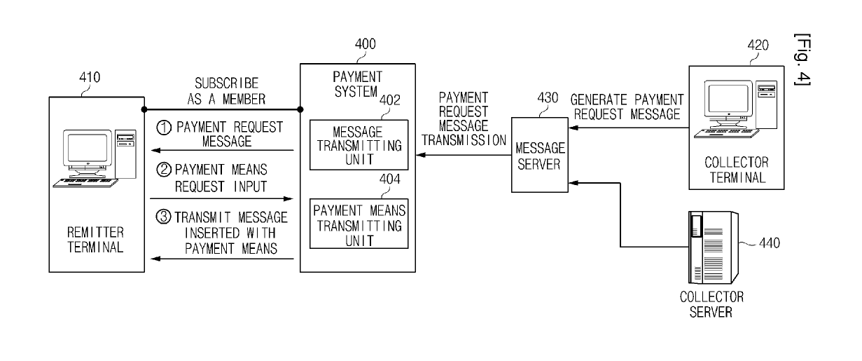

FIG. 4 is a schematic block diagram showing a payment system 400 using message transmission according to another embodiment of the present invention. The embodiment of FIG. 4 corresponds to a case where payment is performed without recognizing a payment request indicator. For example, there are a case where the collector terminal 420 transmits a message including a payment request indicator and the payment request indicator is not recognized, a case where a payment request message not including a payment request indicator is transmitted, or a case where collection information is set not to be display on a message by a remitter or collector.

The payment system 400 using message transmission includes a message transmitting unit 402 and a payment means transmitting unit 404. The message transmitting unit 402 transmits to the remitter terminal 410 the payment request message which is transmitted from the collector terminal 420.

As described above, the payment request message may be any type of messages that can be transmitted between the collector terminal 420 and the remitter terminal 410. For example, the payment request message may be an e-mail, an SMS (short message service) text message, an instant messenger message, or the like.

As described above in FIG. 1, the payment request message can include various types of collection information. The remitter terminal 410 can select a payment means with reference to the collection information. Namely, the collector's desired types of collection information among various types of collection information are included in the payment request message, and the remitter selects a remitter's desired payment means (among the provided payment means) with reference to the included collection information.

Next, when an input of payment means request(a request for transmitting a message inserted with a payment means) transmitted from the remitter terminal 410 is recognized, the payment means transmitting unit 404 transmits to the remitter terminal 410 the message into which the payment means selected by the remitter is inserted.

As described above, the payment means can be selected through the remitter terminal 410. In addition, the payment means can be automatically selected according to preferential settings without selection through the remitter terminal 410. In case of automatic selection, only one type of collection information can be included in the payment request message.

In addition, in a case where the remitter terminal 410 receives a payment request message where a payment request indicator is not set or in a case where the remitter terminal 410 receives a payment request message where a payment request indicator is set but not recognized, the remitter terminal 410 may transmits to the payment means transmitting unit 404 a command of inserting the payment means into the payment request message that is transmitted from the collector terminal 420 and the remitter terminal 410.

In an example for the command of inserting the payment means, the remitter terminal 410 may set (or set again) the payment request indicator in the payment means request input and transmit it to the payment means transmitting unit 404. Accordingly, the payment means transmitting unit 404 can insert the payment means into the payment request message and transmit to the remitter terminal the payment request message again. When the collector terminal 420 transmits to the remitter terminal 410 a different payment request message with respect to a different payment case, the payment means transmitting unit 404 can recognize the payment request indicator and insert the payment means into the different payment request message that is to be transmitted to the remitter terminal 410.

In addition, the payment performing input of requesting payment by using the payment means transmitted from the payment means transmitting unit 404 is input through the remitter terminal 410. The payment performing input may include remittance information corresponding to the selected payment means.

The remittance information can be selected among the remittance information that is stored in the payment system 400. In a case where the remittance information stored in the payment system 400 is provided, the remitter does not need to separately perform inputting, so that it is possible to simplify payment steps and to reduce inconvenience of payment.

The input remittance information may be transmitted to the payment system 400 or directly linked to a payment agency, a card company, or a financial institution through a message, so that the payment can be safely completed.

The payment system using message transmission according to the present invention may be implemented with a separate server as described above. In addition, the payment system may be implemented as hardware or software (programs) that are integrated in the remitter terminal. In addition, the payment system can be classified into a manual processing type and an automatic processing type.

In the manual processing type, the remitter pushes specific keys for performing payment. More specifically, the collector transmits through the collector terminal to the remitter terminal the payment request message including collection information, for example, collector's account number, and card terminal number for payment, and the remitter checks a message alarm and the message transmitted to the remitter terminal.

The remitter pushes a specific key on the message to activate a payment means extraction program so as to extract payment means and collection information corresponding to the payment means. The remitter selects one of the payment means so as to perform payment. If there is only one payment means, the payment is automatically performed.

At this time, the amount can be changed, the remittance can be reserved, and the payment information can be stored. After the payment is performed, when an authentication process is completed, the payment is completed.

In the automatic processing type, the payment means extraction program is automatically activated to perform payment without remitter's pushing a specific key. More specifically, the collector transmits to the remitter terminal the payment request message including collection information, and when the message is transmitted to the remitter terminal, the payment means extraction program is automatically activated.

When the payment means extraction program detects a payment means and collection information corresponding to the payment means, the payment is automatically performed. Namely, payment means such as card payment and deposit without passbook and the associated collection information such as card number and remittance account are extracted, and the payment is performed through the payment means that is selected by the remitter. In addition, if there is only one payment means, the payment is automatically performed.

At this time, the amount can be changed, the remittance can be reserved, and the payment information can be stored. After the payment is performed, when an authentication process is completed, the payment is completed.

In addition, the payment means extraction program and the payment program may be integrally implemented. Namely, even in a case where the collector side is connected to the financial institution, when a message (for example, text, picture, or the like) including the payment means and the collection information is transmitted to the remitter terminal, the remitter terminal uses the payment means extraction program to extract the payment means and the collection information from the message transmitted from the collector side and activate the payment program, so that the payment can be performed.

In addition, the payment means extraction program and the payment program may be separately implemented. Namely, the payment request message transmitted from the collector terminal connected to the financial institution can be blocked from the payment program by using the payment means extraction program, and the payment can be performed.

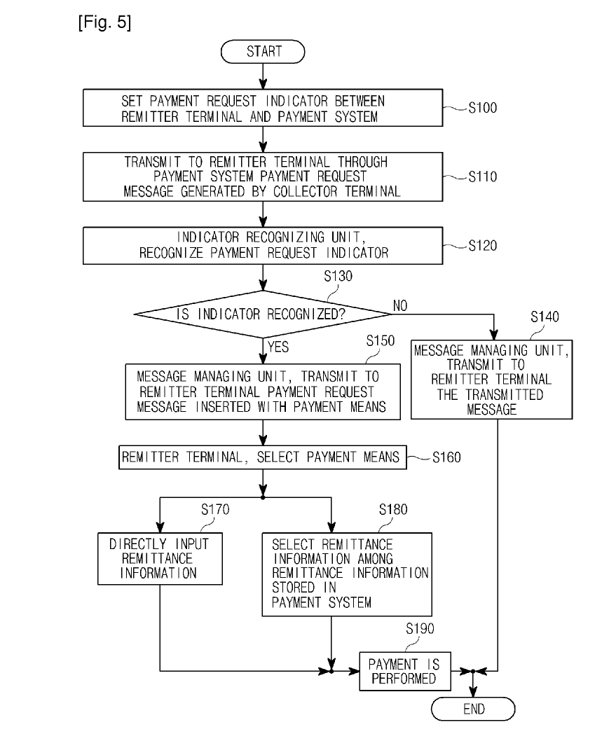

FIG. 5 is a flowchart showing a payment method using message transmission according to another embodiment of the present invention. Firstly, a payment request indicator is set between a remitter terminal and a payment system (S100). The payment request indicator may be an indicator arbitrarily set by a remitter. In addition, the payment request indicator may be an indicator set by the payment system. The payment request indicator is included in a payment request message.

The payment request message generated by the collector terminal is transmitted to the remitter terminal through the payment system (S110). A indicator recognizing unit of the payment system determines whether the set payment request indicator is included (S120 and S130). If the payment request indicator is not recognized, the message is classified as a general message and immediately transmitted to the remitter terminal (S140).

If the payment request indicator is recognized, a message managing unit inserts payment means into the payment request message transmitted from the collector terminal and transmits the message to the remitter terminal (S150). The message inserted with the payment means may further include collection information corresponding to various payment means. In this case, the remitter terminal selects the payment means with reference to the collection information (S160).

After the payment means is selected, the payment may be performed in two manners. In the first manner, the remitter directly inputs remittance information such as remitter's card number and disbursement account number (S170), and the payment is performed (S190). In the second manner, the remittance information is selected from the remittance information stored in the payment system (S180), and the payment is performed (S190). The input remittance information may be transmitted to the payment system or directly linked to a payment agency, a card company, or a financial institution through a message, so that the payment can be safely completed.

Namely, the collector terminal transmits to the remitter terminal only the message (for example, an e-mail and an SMS text message) including the payment request indicator, and the remitter terminal accesses only a financial institution server that is regularly connected by the remitter terminal. Since the remitter terminal is not directly connected to the collector terminal, so that it is possible to acquire safety.

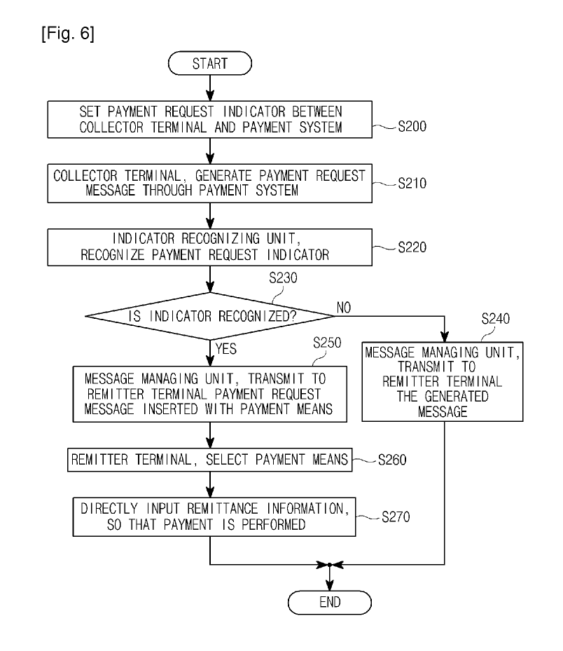

FIG. 6 is a flowchart showing a payment method in a case where a payment system is connected to a collector terminal according to another embodiment of the present invention. Firstly, a payment request indicator is set between a collector terminal and a payment system (S200). The payment request indicator may be an indicator arbitrarily set by a collector. In addition, the payment request indicator may be an indicator set by the payment system. The payment request indicator may be included in a payment request message which is transmitted from the collector terminal the remitter terminal through the payment system (S210).

Next, an indicator recognizing unit of the payment system determines whether the set payment request indicator is included (S220 and S230). If the payment request indicator is not recognized, the message is classified as a general message and immediately transmitted to the remitter terminal (S240).

If the payment request indicator is recognized, a message managing unit inserts payment means into the payment request message transmitted from the collector terminal and transmits the message to the remitter terminal (S250). The message inserted with the payment means may further include collection information corresponding to various payment means. In this case, the remitter terminal selects the payment means with reference to the collection information (S260).

Unlike the embodiment of FIG. 4, after the payment means is selected, the payment is performed, only if the remitter directly inputs remittance information such as remitter's disbursement account number and card number (S270). This is because the remitter is not subscribed as a member of the payment system and the remitter terminal is not connected to the payment system, and thus the remittance information is not stored in the payment system.

The input remittance information may be transmitted to the payment system or directly linked to a payment agency, a card company, or a financial institution through a message, so that the payment can be safely completed.

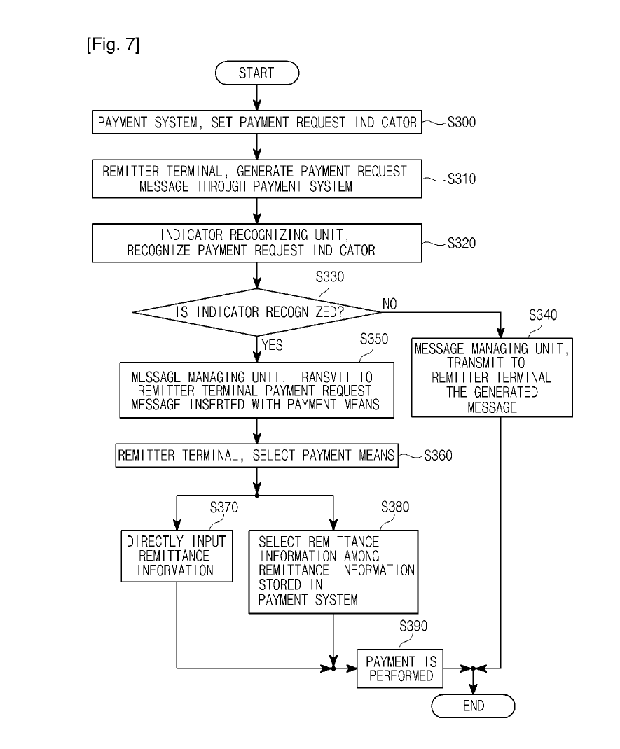

FIG. 7 is a flowchart showing a payment method in a case where a payment system is connected to a collector terminal or a remitter terminal according to another embodiment of the present invention. Firstly, a payment request indicator is set between the payment system and the remitter terminal, between the payment system and the collector terminal, or by the payment system (s300). The payment request indicator is included in a payment request message which is generated by the collector terminal and transmitted to the remitter terminal (S310).

Next, an indicator recognizing unit of the payment system determines whether the set payment request indicator is included (S320 and S330). If the payment request indicator is not recognized, the message is classified as a general message and immediately transmitted to the remitter terminal (S340).

If the payment request indicator is recognized, a message managing unit inserts payment means into the payment request message transmitted from the collector terminal and transmits the message to the remitter terminal (S350). The payment request message may further include various payment means in addition to the above payment means. The remitter terminal selects the payment means with reference to the collection information (S360).

After the payment means is selected, the payment may be performed in two manners, similarly to the embodiment of FIG. 4. In the first manner, the remitter directly inputs remittance information such as remitter's card number and disbursement account number (S370), and the payment is performed (S390). In the second manner, the remittance information is selected from the remittance information stored in the payment system (S380), and the payment is performed (S390). The input remittance information may be transmitted to the payment system or directly linked to a payment agency, a card company, or a financial institution through a message, so that the payment can be safely completed.

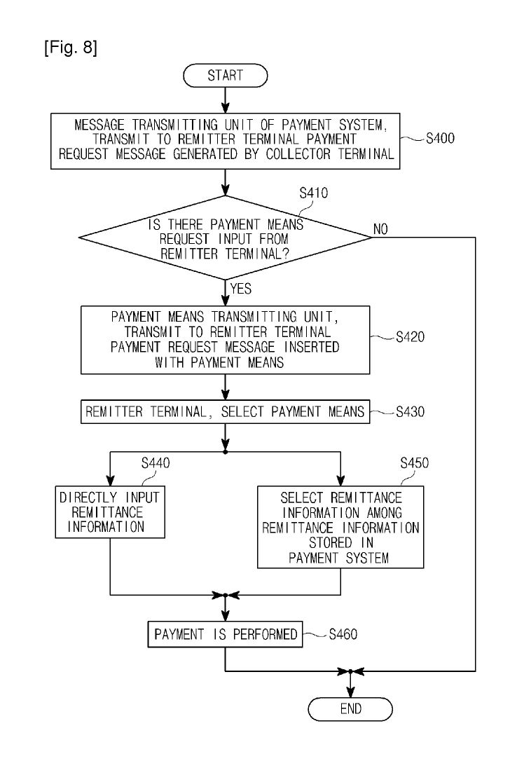

FIG. 8 is a flowchart showing a payment method using message transmission according to another embodiment of the present invention. Firstly, a payment request message generated by a collector terminal is transmitted to a remitter terminal through a message transmitting unit of a payment system (S400). After the payment request message is received, the remitter terminal determines whether there is a payment means request input (S410). If there is no payment means input request, the payment process is immediately ended. If there is a payment means input request, a payment means transmitting unit transmits to the remitter terminal a message inserted with payment means (S420). When the remitter selects a payment means in the remitter terminal (s430), remittance information is input in two cases. In the first case, the remitter directly inputs the remittance information (S440). In the second case, the remittance information is selected among several types of remittance information which are stored in the payment system (S450). If the remittance information is input, the payment is performed (S460).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

While the present invention has been particularly shown and described with reference to exemplary embodiments thereof, it will be understood by those skilled in the art that various changes in form and details may be made therein without departing from the spirit and scope of the present invention as defined by the appended claims. For example, in the above embodiments, the payment system is implemented in a separate server which is located outside the user terminal such the collector terminal and the remitter terminal. However, in other embodiments, the payment system may be integrally implemented within the user terminal. In this case, the payment system may be implemented as software or hardware in the user terminal.

1. A payment system using message transmission comprising:
an indicator recognizing unit which recognizes a payment request indicator included in a payment request message which is transmitted from a collector terminal to a remitter terminal; and
a message managing unit which inserts a payment means into the payment request message so as for the payment means to be output on the remitter terminal when the payment request indicator is recognized, wherein the payment means performs payment according to a payment performing input from the remitter terminal.

2. The payment system according to claim 1, wherein the payment request message includes collection information which is needed so as for a collector to collect a payment amount.

3. The payment system according to claim 2, wherein the collection information includes remitter identification information through which the collector terminal can identify the remitter when the payment is performed.

4. The payment system according to claim 3, wherein the remitter terminal selects the payment means from the collection information.

5. The payment system according to claim 4, wherein the payment performing input includes remittance information corresponding to the selected payment means.

6. The payment system according to claim 1, wherein the payment request indicator is an indicator which is set between the indicator recognizing unit and the remitter terminal.

7. The payment system according to claim 1, wherein the payment request indicator is an indicator which is set between the indicator recognizing unit and the collector terminal.

8. A payment system using message transmission comprising:
a message transmitting unit which transmits to a remitter terminal a payment request message including collection information transmitted from a collector terminal; and
a payment means transmitting unit which transmits to the remitter terminal a message including a payment means, wherein, in a case where, a payment means input request of the remitter terminal is recognized, the payment means performs payment when the remitter terminal inputs a payment performing input.

9. The payment system according to claim 8, wherein the payment request message includes collection information which is needed so as for a collector to collect a payment amount.

10. The payment system according to claim 9, wherein the collection information includes remitter identification information through which the collector terminal can identify the remitter when the payment is performed.

11. The payment system according to claim 10, wherein the remitter terminal selects the payment means from the collection information.

12. The payment system according to claim 9, wherein the payment performing input is input from the remitter terminal, and the payment performing input includes remittance information corresponding to the selected payment means.

13. A payment method using message transmission comprising:
an indicator recognizing step which recognizes a payment request indicator included in a payment request message which is transmitted from a collector terminal to a remitter terminal; and
a message managing step which inserts a payment means into the payment request message so as for the payment means to be output on the remitter terminal when the payment request indicator is recognized, wherein the payment means performs payment according to a payment performing input from the remitter terminal.

14. The payment method according to claim 13, wherein payment request message includes collection information which is needed so as for a collector to collect a payment amount.

15. The payment method according to claim 14, wherein the collection information includes remitter identification information through which the collector terminal can identify the remitter when the payment is performed.

16. The payment method according to claim 15, wherein the remitter terminal selects the payment means from the collection information.

17. The payment method according to claim 16, wherein the payment performing input includes remittance information corresponding to the selected payment means.

18. The payment method according to claim 13, wherein the payment request indicator is an indicator which is set between the indicator recognizing unit and the remitter terminal.

19. The payment method according to claim 13, wherein the payment request indicator is an indicator which is set between the indicator recognizing unit and the collector terminal.

20. A payment method using message transmission comprising:
a message transmission step which transmits to a remitter terminal a payment request message including collection information transmitted from a collector terminal; and
a payment means transmission step which transmits to the remitter terminal a message including a payment means, wherein, in a case where, a payment means input request of the remitter terminal is recognized, the payment means performs payment when the remitter terminal inputs a payment performing input.

21. The payment method according to claim 20, wherein the payment request message includes collection information which is needed so as for a collector to collect a payment amount.

22. The payment method according to claim 21, wherein the collection information includes remitter identification information through which the collector terminal can identify the remitter when the payment is performed.

23. The payment method according to claim 20, wherein the remitter terminal selects the payment means from the collection information.

24. The payment method according to claim 20, wherein the payment performing input is input from the remitter terminal, and the payment performing input includes remittance information corresponding to the selected payment means.

25. A computer program for executing a payment method using message transmission,
the method comprising:
an indicator recognizing step which recognizes a payment request indicator included in a payment request message which is transmitted from a collector terminal to a remitter terminal; and
a message managing step which inserts a payment means into the payment request message so as for the payment means to be output on the remitter terminal when the payment request indicator is recognized, wherein the payment means performs payment according to a payment performing input from the remitter terminal.

26. A computer program for executing a payment method using message transmission,
the method comprising:
a message transmission step which transmits to a remitter terminal a payment request message including collection information transmitted from a collector terminal; and
a payment means transmission step which transmits to the remitter terminal a message including a payment means, wherein, in a case where, a payment means input request of the remitter terminal is recognized, the payment means performs payment when the remitter terminal inputs a payment performing input.
